(19) United States
(12) Patent Application Publication
(10) Pub. No.: US 2005/0155720 A1
(43) Pub. Date: Jul. 21, 2005

(54) Roman shade capable of adjusting light transmittance

(75) Inventors: Ming Nien, Changhua Hsien (TW); David Kuei-Tin Pon, Irvine, CA (US)

Correspondence Address: BACON & THOMAS, PLLC, 625 SLATERS LANE, FOURTH FLOOR, ALEXANDRIA, VA, 22314, US

(73) Assignee: NIEN MADE ENTERPRISE CO., LTD., TAICHUNG (TW)

(21) Appl. No.: 10/832,387

(22) Filed: Apr. 27, 2004

(30) Foreign Application Priority Data
Jan. 15, 2004 (TW) 93200751

(51) Int. Cl. E06B 3/48

(52) U.S. Cl. 160/84.01

(57) ABSTRACT

A light transmittance adjustable Roman shade includes soft shading elements arranged in parallel at different elevations below a headrail. Each shading element has a curved bottom suspension such that the Roman shade shows a waterfall-like folding face. A cord member is joined in proper order with a top side of each shading element and has a top end connected to the headrail. Another cord member is joined in proper order with a bottom side of each shading element and has a top end wound around a shaft that is rotatably mounted inside the headrail for enabling the user to control a gap between each two adjacent shading elements.

### BACKGROUND OF THE INVENTION

1. Field of the Invention

The present invention relates generally to window blinds and, more specifically, to a Roman shade capable of adjusting light transmittance therethrough.

2. Description of the Related Art

Various vertical window blinds including Venetian blinds, Roller shades, Roman shades, and the like are known. These window blinds commonly comprise a headrail for fastening to the top side of a window, a blind body, which is formed of a curtain, a set of slats and a bottom rail, a plurality of shading cloths or etc., suspended from the headrail, and a lifting controller for moving the blind body upwards to a received status or downwards to an extended status.

A Venetian blind is the most popular blind that shows a modem feature. The blind body, which is formed of slats and a bottom rail, of a Venetian blind can be moved vertically between the received position and the extended position, and can also be controlled to tilt the slats, changing the light transmittance between each two adjacent slats. A Roman shade shows a classical beauty. It can be controlled to fold the blind body into a waterfall-like folding status that shows a classical elegance. However, a conventional Roman shade can only be folded upwards or extended downwards. It cannot be controlled to adjust light transmittance as a Venetian blind does.

### SUMMARY OF THE INVENTION

It is the primary objective of the present invention to provide a Roman shade that shows a classical beauty, and can be controlled to adjust the transmission of light into the house.

It is another objective of the present invention to provide a Roman shade, which has the advantages of elegant outer looking and better operational function.

To achieve these objectives of the present invention, the Roman shade provided by the present invention comprises a headrail, a plurality of soft shading elements, at least two first cord members, at least two second cord members and a switching mechanism. The shading elements are serially arranged at different elevations below the headrail. The shading elements each have a top side and a bottom side. The first cord members are spacedly vertically suspended below the headrail and respectively joined to the top side of each the shading element. The first cord members each have a top end fixedly connected to the headrail. The second cord members are spacedly vertically suspended below the headrail and respectively joined to the bottom side of each the shading element such that a distance between the top and bottom sides of each of the shading elements is smaller than a width between the top and bottom sides of each of the shading elements when the shading element is fully extended so as to form a curved bottom suspension at each of the shading elements. The second cord members each have a top end. The switching mechanism is mounted in the headrail and connected to the top end of each the second cord member for rolling up the second cord members so as to further adjust the distance between the top and bottom sides of each the shading element.

Preferably, the Roman shade provided by the present invention further comprises at least two third cord members spacedly vertically suspended below the headrail and respectively inserted through the top and bottom sides of the shading elements, and a lifting mechanism. The third cord members each have a bottom end fixedly connected to the bottom side of a lowest shading element of the shading elements, and a top end. The lifting mechanism is mounted in the headrail and coupled to the top end of each the third cord member for driving the third cord members to lift and lower the shading elements between a received condition and an extended condition.

### BRIEF DESCRIPTION OF THE DRAWINGS

FIG. 1 is a front view of a preferred embodiment of the present invention.

FIG. 2 is a schematic drawing of the preferred embodiment of the present invention, showing the connection between the first cord members and the shading elements.

FIG. 3 is a schematic drawing of the preferred embodiment of the present invention, showing the connection between the second cord members and the shading elements.

FIG. 4 is a schematic drawing of the preferred embodiment of the present invention, showing the connection between the third cord members and the shading elements.

FIG. 5 is a schematic drawing showing a closed status of the shading elements according to the present invention.

FIG. 6 is a schematic drawing showing an opened status of the shading elements according to the present invention.

FIG. 7 is a schematic drawing showing a received status of the shading elements according to the present invention.

### DETAILED DESCRIPTION OF THE INVENTION

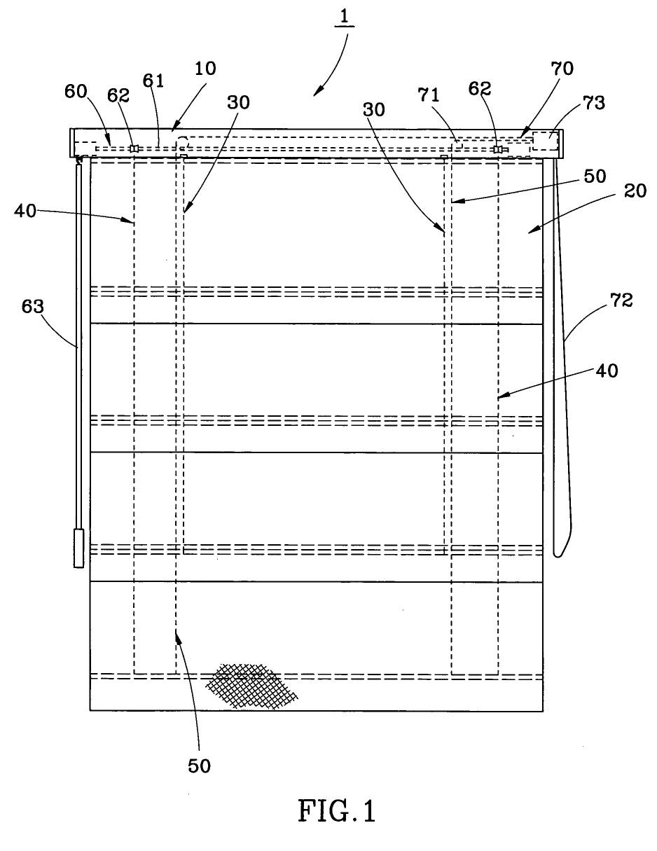

Referring to FIG. 1, a light transmittance adjustable Roman shade 1 is shown comprised of a headrail 10, a plurality of shading elements 20, two first cord members 30, two second cord members 40, two third cord members 50, a switching mechanism 60, and a lifting mechanism 70.

The headrail 10 is a hollow frame bar adapted to fasten to the top side of a window.

The shading elements 20 are rectangular soft members made of woven cloth, cotton cloth, plastic sheet, or any of a variety of soft materials, each having two long sides respectively mounted with a first transverse rod 21 and a second transverse rod 22. Because of the effect of the first transverse rod 21 and the second transverse rod 22, each shading element 20 can only be curved along the short sides. The transverse rods 21 and 22 each have two through holes 23 respectively provided near two ends thereof (see FIG. 4). The shading elements 20 are serially arranged in parallel at different elevations below the headrail 10 with the long sides of each shading element 20 set in parallel to the headrail 10, keeping the first transverse rod 21 disposed at the top side of the respective shading element 20 and the second transverse rod 22 disposed at the bottom side of the respective shading element 20.

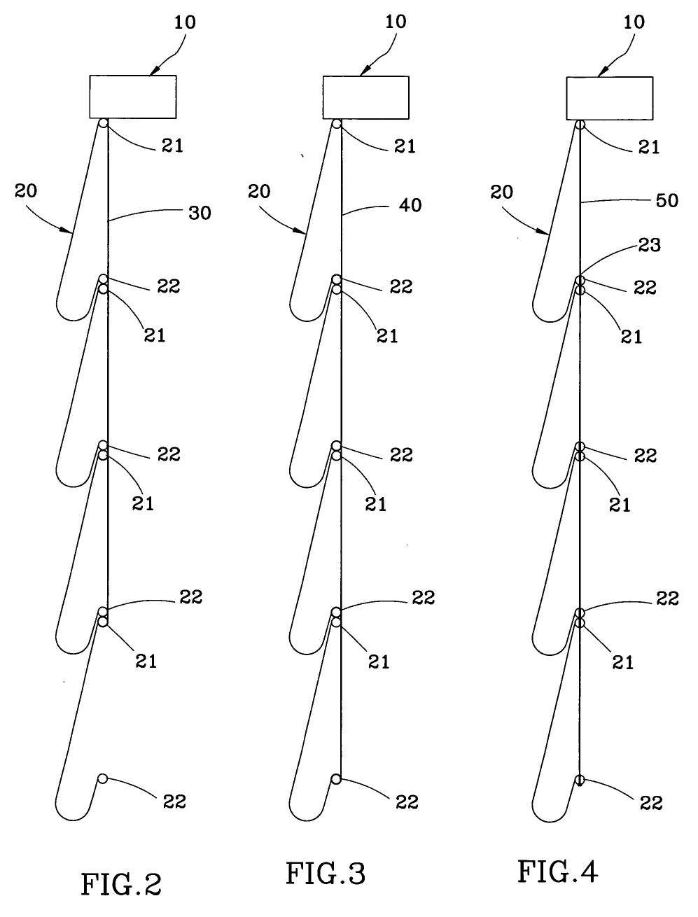

Referring to FIG. 2 and FIG. 1 again, the two first cord members 10 are bilaterally spacedly suspended below the headrail 10, each having a top end fixedly connected to the headrail 10, a bottom end extended vertically downwards, and a cord body serially joined to the first transverse rods 21 of the shading elements 20, keeping the first transverse rod 21 disposed at the top side of the respective shading element 20 and the second transverse rod 22 disposed at the bottom side of the respective shading element 20, and having the distance between the first transverse rods 21 of each two adjacent shading elements 20 set to be smaller than the width of the fully extended status of each shading element 20 between the respective first transverse rod 21 and the respective second transverse rod 22. Further, the bottom end of each first cord member 30 is fixedly connected to the first transverse rod 21 of the lowest shading element of the shading elements 20.

Referring to FIG. 3 and FIG. 1 again, the second cord members 40 are bilaterally spacedly suspended below the headrail 10, each having a top end inserted into the inside of the headrail 10 (this will be described further), a bottom end extended vertically downwards, and a cord body serially joined to the second transverse rods 22 of the shading elements 20, keeping the second transverse rod 22 of an upper shading element of each two adjacent shading elements 20 slightly above the first transverse rods 21 of a lower shading element of the each two adjacent shading elements 20. Under this position, the distance between the top and bottom sides of each shading element 20 is smaller than the width between the top and bottom sides of each shading element 20 when it is fully extended out, and therefore each shading element 20 shows an arched bottom suspension. Further, the bottom end of each second cord member 40 is fixedly connected to the second transverse rod 22 of the lowest shading element of the shading elements 20.

Referring to FIG. 4 and FIG. 1 again, the third cord members 50 are bilaterally spacedly suspended below the headrail 10, each having a top end inserted into the inside of the headrail 10 (this will be described further) and a bottom end respectively inserted through the through holes 23 of the first transverse rods 21 and the second transverse rods 22 and then fixedly connected to the second transverse rod 22 of the lowest shading element of the shading elements 20.

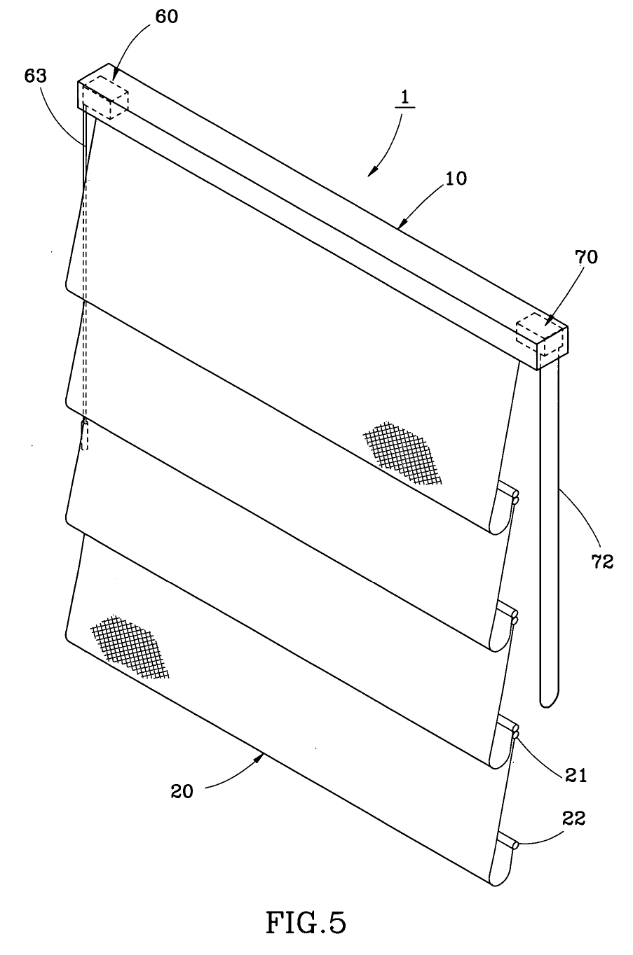

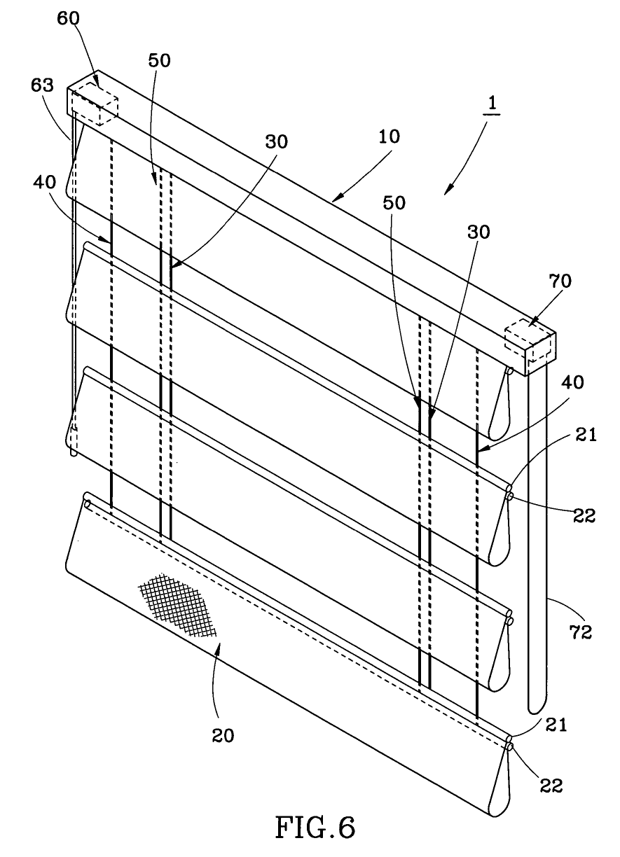

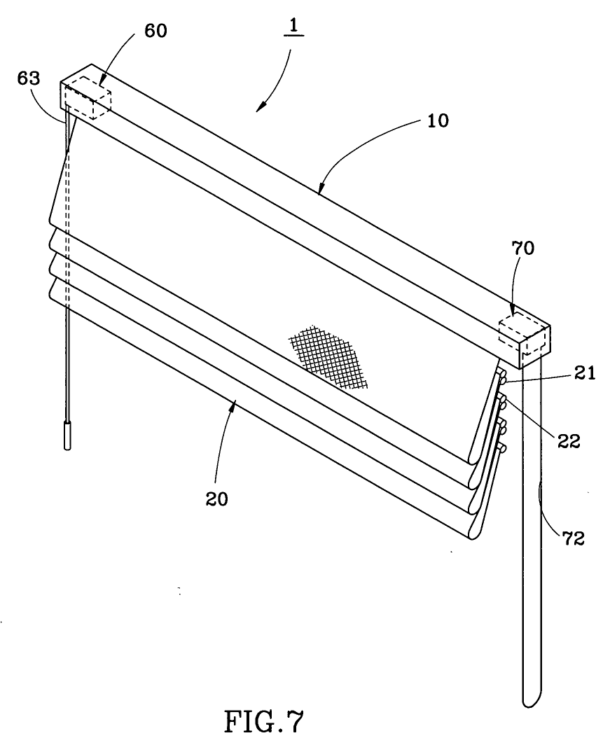

Referring to FIGS. 5 and 6 and FIG. 1 again, the switching mechanism 60 comprises a shaft 61 horizontally rotatably mounted inside the headrail 10 and two bobbins 62 respectively mounted on the shaft 61 near the two distal ends of the shaft. The top end of each second cord member 40 is respectively connected to the bobbins 62. Therefore, rotating the shaft 61 causes the bobbins 62 to roll up or let off the second cord members 40. When rotating the shaft 61 in one direction to roll up the second cord members 40, the second transverse rods 22 of the shading elements 20 are respectively moved upwards toward the first transverse rods 21 of the shading elements 20, and a gap is produced and gradually increased between each two adjacent shading elements 20, and therefore the light transmission area between each two adjacent shading elements 20 is relatively increased (see FIG. 6). When rotating the shaft 61 in the reversed direction to let off the second cord members 40, the gap between each two adjacent shading elements 20 is gradually reduced, and therefore the light transmission area between each two adjacent shading elements 20 is relatively reduced (see FIG. 5). The switching mechanism 60 further comprises a control rod 63 vertically suspended at one lateral side (the left side in the drawings) of the headrail and coupled to the shaft 61 for rotation by the user to rotate the shaft 61. It is to be understood that the coupling structure between the control rod 63 and the shaft 61 can easily be achieved by conventional techniques, for example, through a worm and a gear.

Referring to FIG. 7 and FIGS. 1 and 5 again, the lifting mechanism 70 comprises a lift lock 73 mounted in one end (the right end) of the headrail 10, two rollers 71 respectively rotatably mounted inside the headrail 10, and a lift cord 72. The lift cord 72 has the cord body thereof wound round the rollers 71 and extended out of the headrail 10 through the lift lock 73, and the two ends respectively joined to the top ends of the third cord members 50. Therefore, when the user pulls the lift cord 72, the third cord members 50 will be lifted to move the shading elements 20 upwards to a received status (see FIG. 7). On the contrary, loosening the lift cord 72 to lower the third cord members 50, the shading elements 20 are moved downwards to an extended status to shield the window (see FIG. 5). Therefore, the user can adjust the shielding elevation of the Roman shade 1 and then lock the Roman shade 1 in the adjusted position by the lift lock 73. It is to be understood that the lift lock 73 is of the known art; no further description in this regard is necessary.

During operation, the user can rotate the control rod 63 to adjust the light transmission area between each two adjacent shading elements 20. When the second transverse rod 22 and first transverse rod 21 of each shading element 20 are contacted together, the maximum light transmission area between each two adjacent shading elements 20 is obtained. When lowering the respective second transverse rods 22 from the respective first transverse rods, the light transmission area between each two adjacent shading elements 20 is gradually reduced, and less amount of light is allowed to pass to the inside of the house. When the second transverse rod 22 of an upper shading element 20 of two adjacent shading elements 20 and the first transverse rod 21 of a lower shading element 20 of the two adjacent shading elements are contacted together, outside light is prohibited from passing through the Roman shade 1. Further, the user can operate the lift cord 72 to receive the shading elements 20 to the bottom side of the headrail 10, or to lower the shading elements 20 to the fully extended status to shield the whole window.

As indicated above, when extended out the shading elements 20, the Roman shade 1 shows an elegant outer looking. At this time, the curved bottom suspensions of the shading elements 20 show a waterfall-like beauty. Further, the feature of allowing the user to adjust light transmittance greatly attracts consumers to buy the Roman shade.

The invention is not limited to the condition that the curved bottom suspension of one shading element covers the upper part of the adjacent lower shading element. Modification can be may be made without departing from the spirit and scope of the invention. For example, the Roman blind can be made such that the curved bottom suspension of one shading element is suspended at the elevation equal to the top side of the adjacent lower shading element. Accordingly, the invention is not to be limited except as by the appended claims.

1. A Roman shade comprising:
a headrail;
a plurality of soft shading elements serially arranged at different elevations below said headrail, said shading elements each having a top side and a bottom side;
at least two first cord members spacedly vertically suspended below said headrail and respectively joined to the top side of each said shading element, said first cord members each having a top end fixedly connected to said headrail;
at least two second cord members spacedly vertically suspended below said headrail and respectively joined to the bottom side of each said shading element to hold the bottom side of an upper said shading element of two adjacent said shading elements above the top side of a lower said shading element of the two adjacent said shading elements, said second cord members each having a top end; and
a switching mechanism mounted in said headrail and connected to the top end of each said second cord member for rolling up said second cord members so as to further adjust a distance between the top and bottom sides of each said shading element.

2. The Roman shade as claimed in claim 1, wherein the top and bottom sides of said shading elements are respective fastened to said first cord members and said second cord members such that the distance between the top and bottom sides of each said shading element connected to said first cord members and said second cord members is shorter than a width between the top and bottom sides of each said shading element when said shading element is fully extended out.

3. The Roman shade as claimed in claim 1, further comprising at least two third cord members spacedly vertically suspended below said headrail and respectively inserted through the top and bottom sides of said shading elements, said third cord members each having a top end and a bottom end fixedly connected to the bottom side of a lowest said shading element of said shading elements, and a lifting mechanism mounted in said headrail and coupled to the top end of each said third cord member for driving said third cord members to lift and lower said shading elements between a received condition and an extended condition.

4. The Roman shade as claimed in claim 1, wherein the bottom side of the upper said shading element of each two adjacent said shading elements and the top side of the lower shading element of the two adjacent said shading elements are disposed at same elevation when said switching mechanism releases said second cord members to extend the distance between the top and bottom sides of each said shading element to a maximum status.

5. The Roman shade as claimed in claim 1, wherein said shading elements each have the top side thereof mounted with a first transverse rod and the bottom side thereof mounted with a second transverse rod.

6. The Roman shade as claimed in claim 3, wherein said shading elements each have the top side thereof mounted with a first transverse rod and the bottom side thereof mounted with a second transverse rod, said first transverse rods and said second transverse rods each having at least two through holes for the passing of said at least two third cord members.

7. The Roman shade as claimed in claim 1, wherein said switching mechanism comprises at least two bobbins respectively connected to the top ends of said at least second cord members for winding thereon said second cord members.

8. A window blind comprising:
a headrail;
a plurality of soft shading elements serially arranged at different elevations below said headrail, said shading elements each having a top side and. a bottom side;
at least two first cord members spacedly vertically suspended below said headrail and respectively joined to the top side of each said shading element, said first cord members each having a top end fixedly connected to said headrail; and
at least two second cord members spacedly vertically suspended below said headrail and respectively joined to the bottom side of each said shading element to hold the bottom side of an upper said shading element of two adjacent said shading elements above the top side of a lower said shading element of the two adjacent said shading elements.

9. The window blind as claimed in claim 8, wherein the top and bottom sides of said shading elements are respective fastened to said first cord members and said second cord members such that a distance between the top and bottom sides of each said shading element connected to said first cord members and said second cord members is shorter than a width between the top and bottom sides of each said shading element when said shading element is fully extended out.

10. The window blind as claimed in claim 8, further comprising at least two third cord members spacedly vertically suspended below said headrail and respectively inserted through the top and bottom sides of said shading elements, said third cord members each having a bottom end fixedly connected to the bottom side of a lowest said shading element of said shading elements.

11. The window blind as claimed in claim 10, wherein said shading elements each have the top side thereof mounted with a first transverse rod and the bottom side thereof mounted with a second transverse rod, said first transverse rods and said second transverse rods each having at least two through holes for the passing of said at least two third cord members.

12. The window blind as claimed in claim 8, wherein said shading elements each have the top side thereof mounted with a first transverse rod and the bottom side thereof mounted with a second transverse rod.
